(19) United States
(12) Patent Application Publication
(10) Pub. No.: US 2025/0340247 A1
(43) Pub. Date: Nov. 6, 2025

(54) End Wall for a Motor Vehicle Body, Motor Vehicle and Method

(71) Applicant: Bayerische Motoren Werke Aktiengesellschaft, Muenchen (DE)

(72) Inventors: Richard EILETZ, Deisenhofen (DE); Alexander-Wilhelm OTTE, Egenhofen (DE); Klaus POST, Finsing (DE)

(21) Appl. No.: 19/195,793

(22) Filed: May 1, 2025

(30) Foreign Application Priority Data
May 2, 2024 (DE) 10 2024 112 313.3

(51) Int. Cl. B62D 25/20

(52) U.S. Cl. CPC B62D 25/2027

(57) ABSTRACT

An end wall for a motor vehicle body having a lower end wall part, an upper end wall part, which extends further upward in the vehicle vertical direction than the lower end wall part, and a connecting part, via which the lower end wall part and the upper end wall part are connected to each other. The connecting part protrudes obliquely or perpendicular from the lower end wall part and the upper end wall part and has a media feedthrough opening through which at least one line element can be guided for connecting a first component, which is to be arranged in front of the end wall, and a second component, which is arranged behind the end wall and through which, if required, further line elements can be guided for connecting further components, which are arranged in front of or behind the end wall.

### CROSS REFERENCE TO RELATED APPLICATION

This application claims priority under 35 U.S.C. § 119 from German Patent Application No. 10 2024 112 313.3, filed May 2, 2024, the entire disclosure of which is herein expressly incorporated by reference.

### BACKGROUND AND SUMMARY

This disclosure relates to an end wall for a motor vehicle body. The disclosure further relates to a motor vehicle having such an end wall and to a method for producing a motor vehicle having a bodyshell with a floor assembly.

DE 10 2017 119 128 B4 discloses a body structure of an electric vehicle, having an end wall forwardly bounding a passenger compartment and having longitudinal members extending forward, as seen from the end wall, and having a floor assembly which extends rearward, as seen from the end wall, and on which a traction battery of the electric vehicle can be mounted.

Furthermore, DE 10 2015 210 330 A1 discloses a group of motor vehicles, wherein the motor vehicles of each group have at least one module which is in the form of an identical part.

It is an object of the disclosure to provide an end wall for a motor vehicle body, a motor vehicle and a method for producing a motor vehicle having a bodyshell with a floor assembly such that an outlay on production of the motor vehicle can be kept particularly low.

A first aspect of the disclosure relates to an end wall for a motor vehicle body, in particular for a floor assembly of the motor vehicle body. The motor vehicle body is a, preferably self-supporting, body for a motor vehicle or of the motor vehicle. The body may also be referred to as a bodyshell. The motor vehicle body, in particular in its completely produced state, preferably has the end wall.

The end wall, in particular in its installed position in the motor vehicle, is preferably provided for bounding or forming an interior of the motor vehicle forward in the motor vehicle longitudinal direction. In other words, the interior forward in the vehicle longitudinal direction can be bounded or is bounded by the end wall. Thus, the interior is arranged behind the end wall in the motor vehicle longitudinal direction. The interior, which may also be referred to as the vehicle interior, is understood here as meaning a passenger compartment or a passenger cell. Preferably, a front compartment of the motor vehicle extends in front of the end wall in the vehicle longitudinal direction, wherein the front compartment may also be referred to as an external compartment. Thus, the end wall bounds or forms the front compartment, for example to the rear in the vehicle longitudinal direction. The end wall is thus provided in particular for separating the interior from the front compartment.

The end wall has at least a lower end wall part and at least an upper end wall part, which extends further upward at least in certain regions in the vehicle vertical direction than the lower end wall part. This means that at least a partial region of the upper end wall part, in particular in the installed position of the end wall in the motor vehicle body or the motor vehicle, is arranged further upward in the vehicle vertical direction than the lower end wall part. In other words, the upper end wall part is arranged further upward at least in certain regions in the motor vehicle vertical direction than the lower end wall part. The upper end wall part may also be referred to as the upper portion of the end wall and the lower end wall part may also be referred to as the lower portion of the end wall.

Furthermore, the end wall has at least one connecting part, via which the lower end wall part and the upper end wall part are connected to each other, for example directly. In other words, the connecting part of the end wall is connected to the lower end wall part and to the upper end wall part, the connecting part being arranged at least in certain sections in the vehicle vertical direction between the lower end wall part and the upper end wall part. For example, the connecting part is connected downward in the vehicle vertical direction to the upper end wall part and upward in the vehicle vertical direction to the lower end wall part. The lower end wall part, the upper end wall part and the connecting part can be formed separately from one another or can be formed in one piece together. The connecting part can thus be formed in one piece on the lower end wall part and in one piece on the upper end wall part, as a result of which the upper end wall part and the lower end wall part can be connected in one piece to each other. It is thus provided, for example, that the end wall is formed in one piece. Alternatively, the end wall can also be formed in multiple pieces.

In order to be able to keep an outlay on production, in particular an outlay on assembly, of the motor vehicle particularly low, it is provided according to the disclosure that the connecting part protrudes obliquely or perpendicular from the lower end wall part and the upper end wall part. In other words, the connecting part extends obliquely or perpendicular to the lower end wall part and the upper end wall part. The connecting part has at least one, in particular horizontally arranged, media feedthrough opening, which may also be referred to as media through opening. In other words, the media feedthrough opening is arranged in the connecting part or is formed by the connecting part, in particular completely. In other words, an axial direction of the media feedthrough opening extends obliquely or perpendicular to the lower end wall part and the upper end wall part. Through the media feedthrough opening, at least one line element can be guided for, for example data-transmittingly, electrically and/or fluidically, connecting a first component, which, in particular in the installed position of the end wall in the motor vehicle body or in the motor vehicle, is to be arranged or is arranged in front of the end wall in the vehicle longitudinal direction, and a second component, which, in particular in the installed position of the end wall in the motor vehicle body or in the motor vehicle, is to be arranged or is arranged behind the end wall in the vehicle longitudinal direction. This means that the components are connectable or are connected to one another via the media feedthrough opening, in particular data-transmittingly, electrically and/or fluidically. In other words, by way of the media feedthrough opening, a data-transmitting, electrical and/or fluidic connection running downward at least in certain regions in the vehicle vertical direction can be brought about or is brought about between the components.

If required, further line elements for connecting further components, for example, main control units and/or power distributors, which are arranged in front or behind the end wall in the vehicle longitudinal direction, can be guided through the media feedthrough opening or introduced in the form of direct contacting.

The disclosure is based in particular on the following findings and considerations: in conventional vehicle manufacturing, serial assembly can be provided, in which, for example, manual assembly of a cable harness, including passage through an end wall, marriage with the drive and chassis, small-parts assembly of individual components of an interior of the motor vehicle in succession and/or further, separate passages of lines through the end wall are carried out. This may conventionally require a particularly long amount of time, for example for the manual assembly of the cable harness, especially for its passages through the end wall. In addition, a particularly high technical outlay may be necessary for sealing all of the line passages through the end wall.

By contrast, by way of the end wall according to the disclosure, the components can be connected to one another with a particularly low outlay via the media feedthrough opening, for example via a connection panel arranged in the media feedthrough opening. This integrated and horizontally aligned connection panel can have the at least one line element for connecting the components. This connection panel can thus be understood as meaning a central module interface in order, for example, to restrict all of the line passages through the end wall to an opening, in particular precisely one opening, in the form of the media feedthrough opening. These line passages can comprise connections to a drive module and/or energy module of the motor vehicle. Owing to the fact that the media feedthrough opening is arranged in the connecting part or to the fact that the connecting part has the media feedthrough opening, the media feedthrough opening faces downward in the motor vehicle vertical direction. The components can therefore be connected to one another with particularly little outlay; in particular, complicated or awkward guiding through of individual line elements in hard-to-reach installation spaces can be avoided. A number of assembly steps for connecting the components and thus, for example, for the connection panel can be kept particularly low, as a result of which, for example, only one such assembly step, in particular in the vertical direction, may be necessary. This affords the possibility that a large module which has the second component and which may also be referred to as an assembly module can be joined to the motor vehicle body, in particular the floor assembly, vertically from the top downward, based on the vehicle vertical direction. Further, a module which has a first component which may also be referred to as the first module can be joined vertically from the bottom upward, based on the vehicle vertical direction. These two volumes in the form of the modules or components can be connected to each other via the media feedthrough opening, in particular via the connection panel arranged in the media feedthrough opening, of the end wall, for example above an end wall cross member, in particular data-transmittingly, electrically and/or fluidically. Thus, a simplification of the line passages through the end wall and an associated particularly reduced assembly time can be achieved. This can lead to a reduction in costs, in particular to a reduction in production costs of the motor vehicle. All in all, it can be seen that a vehicle concept of the motor vehicle with greater or particularly great modularization of systems of the motor vehicle can be brought about to simplify vehicle assembly and in particular to reduce the number of parts of the motor vehicle. Therefore, in particular, a central module interface which is arranged or is to be arranged in the media feedthrough opening can be made possible in the form of the connection panel mentioned in the region of the end wall.

In a further refinement, it is provided that the axial direction of the media feedthrough opening extends parallel to the vehicle vertical direction, in particular in the installed position of the end wall in the motor vehicle or the motor vehicle body. In other words, the axial direction of the media feedthrough opening and the vehicle vertical direction run parallel to each other. Alternatively or additionally, the axial direction of the media feedthrough opening, in particular in the installed position of the end wall in the motor vehicle or the motor vehicle body, extends at an angle which is less than 45 degrees, in particular less than 30, 20, 10 or 5 degrees, with respect to the vehicle vertical direction. In other words, a main direction of extent of the media feedthrough opening runs at least substantially in the motor vehicle vertical direction. This means that the largest of all the vectorial components of the axial direction runs in the motor vehicle vertical direction. Owing to the parallel arrangement or the arrangement at the angle, the outlay on production, in particular the outlay on assembly, of the motor vehicle can be kept particularly low. This is because when joining the components or modules, the components can be connected to one another with particularly little outlay via the media feedthrough opening. Thus, any further assembly operations for connecting the components can be omitted, since even during the joining of the components or modules the components can be connected, specifically, in particular when the connection panel is arranged in the media feedthrough opening. It is particularly preferably provided that the axial direction of the media feedthrough opening at least substantially runs in the vehicle vertical direction, that is, parallel to the vehicle vertical direction, specifically, in particular when the end wall is in its installed position in the motor vehicle body or in the motor vehicle.

In a further refinement, it is provided that the connecting part, in particular in the installed position of the end wall in the motor vehicle body or the motor vehicle, protrudes, in particular obliquely or perpendicular, from the upper end wall part to the rear in the vehicle longitudinal direction. In other words, the connecting part is connected to the upper end wall part to the rear in the vehicle longitudinal direction. The connecting part, in particular in the installed position of the end wall in the motor vehicle body or the motor vehicle, protrudes, in particular obliquely or perpendicular, from the lower end wall part to the front in the vehicle longitudinal direction. In other words, the connecting part is connected to the lower end wall part to the front in the vehicle longitudinal direction. This means that the connecting part extends at least in certain regions in the vehicle longitudinal direction between the upper end wall part and the lower end wall part. Thus, an assembly compartment for arranging or for mounting the first component, for example, the first module, can be provided behind the end wall, based on the vehicle longitudinal direction, and below the connecting part, based on the vehicle vertical direction. Furthermore, an assembly compartment for arranging or for mounting the second component, for example, the second module, can be provided behind the end wall, based on the vehicle longitudinal direction, and above the connecting part, based on the vehicle vertical direction. The assembly of the motor vehicle can thus be particularly simplified, because the first component or the first module can be mounted from below in the vertical joining direction with particularly little effort and the second component or the second module can be mounted from above in the vertical joining direction with particularly little effort.

In a further refinement, it is provided that the line element for connecting a thermal management module, in particular data-transmittingly, electrically and/or fluidically, as the first component, and an interior air conditioning device, as the second component, can be guided or is guided through the media feedthrough opening. In other words, the first component is designed as a thermal management module and the second component is designed as a thermal management module and the second component is designed as an interior air conditioning device.

Thus, the assembly of the thermal management module and the interior air conditioning device can be particularly simplified, because instead of particularly complex assembly processes for connecting the thermal management module and the interior air conditioning device with conventional end wall passages, the connection of the thermal management module and the interior air conditioning device can be undertaken in a particularly time-saving way through the horizontally oriented media feedthrough opening.

Thermal management module is understood here as meaning a temperature control device, by way of which at least one device, that is, one or more devices of the motor vehicle, can be cooled and/or can be heated. For example, the device or one of the devices is a drive device of the motor vehicle, by way of which the motor vehicle is drivable. This means that cold and/or heat can be provided for the drive device by way of the thermal management module. For example, the device or one of the devices is a central computer which can be arranged or is arranged in the interior and which can be cooled, for example, by way of the thermal management module via coolant and/or refrigerant. The thermal management module comprises, for example, at least one coolant circuit through which a coolant can flow and/or at least one refrigerant circuit through which a refrigerant can flow. The coolant is, for example, water, as a result of which the coolant circuit may also be referred to as a water circuit.

The interior air conditioning device is understood here as meaning an air conditioning device, by way of which the interior can be air conditioned or can be cooled and/or can be heated. The interior air conditioning device may therefore also be referred to as an air conditioning unit, in particular heating air conditioning unit. Preferably, the interior air conditioning device is one of the devices mentioned. This means that the interior air conditioning device can be heated and/or can be cooled by the thermal management module, in particular in order to air condition the interior. The thermal management module can thus provide heat and/or cold for the interior air conditioning device.

In a further refinement, it is provided that the connecting part has a first support region which, in particular in the installed position of the end wall in the motor vehicle body or the motor vehicle, faces downward in the vehicle vertical direction and via which the first component can be supported or is supported on the end wall, for example directly. In other words, the first support region is designed or provided for the first component, for example a housing element of the first component, to lie against the end wall. That the connecting part faces downward in the vehicle vertical direction can be understood as meaning in particular that the first support region of the connecting part faces downward in the vehicle vertical direction. Furthermore, the connecting part has a second support region which, in particular in the installed position of the end wall in the motor vehicle body or the motor vehicle, faces upward in the vehicle vertical direction and via which the second component can be supported or is supported on the end wall, for example directly. In other words, the second support region is provided or designed for the second component, for example a housing element of the second component, to lie against the end wall. That the second support region faces upward in the vehicle vertical direction can be understood as meaning in particular that the second support region faces upward in the vehicle vertical direction. By support of the respective component on the respective support region, the assembly of the components and thus the production of the motor vehicle can be carried out with particularly little effort. The respective component can be moved in the respective joining direction for connecting to the floor assembly and can be applied to the respective support region, if the respective component is in its respective installed position in the motor vehicle. The respective component can thus be brought in a defined manner into its installed position in the motor vehicle.

A second aspect of the disclosure relates to a motor vehicle. Advantages and advantageous refinements of the first aspect of the disclosure can be considered to be advantages and advantageous refinements of the second aspect of the disclosure, and vice versa. The motor vehicle, in particular a body of the motor vehicle, has an end wall according to the first aspect of the disclosure.

The motor vehicle is, for example, in the form of a motor vehicle, in particular a passenger vehicle. For example, the motor vehicle is in the form of an electrically drivable motor vehicle. This means that the motor vehicle has at least one electric machine, by way of which the motor vehicle can be driven. Thus, the motor vehicle is in the form, for example, of a battery-electric vehicle (BEV) or a hybrid vehicle.

A third aspect of the disclosure relates to a method for producing a motor vehicle having a bodyshell with a floor assembly, in particular according to the second aspect of the disclosure. The floor assembly or the bodyshell has at least one end wall, in particular according to the first aspect of the disclosure. Advantages and advantageous refinements of the first and second aspect of the disclosure can be considered to be advantages and advantageous refinements of the third aspect of the disclosure, and vice versa.

The end wall has at least one lower end wall part, at least one upper end wall part, which extends further upward in the vehicle vertical direction than the lower end wall part, and at least one connecting part which protrudes obliquely or perpendicular from the lower end wall part and the upper end wall part. The lower end wall part and the upper end wall part are connected to each other, for example directly, via the connecting part.

In order to be able to keep an outlay on production of the motor vehicle, in particular an outlay on assembly, particularly low, at least the following steps, which may also be referred to as assembly steps, are carried out in the method:
fastening a first module having at least one first component to the floor assembly, in particular directly, in a first joining direction running upward in the vehicle vertical direction, wherein at least the first component is arranged on a side of the end wall facing forward in the vehicle longitudinal direction, and
fastening a second module having at least one second component to the floor assembly, for example directly, in a second joining direction running downward in the vehicle vertical direction, wherein at least the second component is arranged on a side of the end wall facing rearward in the vehicle longitudinal direction, and
connecting, in particular data-transmittingly, electrically and/or fluidically connecting, the components via an, in particular horizontal or horizontally running, media feedthrough opening of the connecting part of the end wall.

This may be understood to mean in particular the following. The first module is fastened to the floor assembly in the first joining direction, as a result of which the first module together with the first component, in particular for fastening the first component or the first module, is connected, for example directly, to the floor assembly. After the fastening, at least the first component of the first module is located on that side of the end wall which faces forward in the vehicle longitudinal direction. The first component is thus a component which can be arranged or is arranged in a front compartment, which may also be referred to as the engine compartment. The first joining direction running upward in the vehicle vertical direction is understood here as meaning that the first module and thus in particular the first component is moved upward in the vehicle vertical direction relative to the floor assembly in order to fasten the first component or the first module to the floor assembly. The second module is fastened to the floor assembly in the second joining direction, as a result of which the second module together with the second component, in particular for fastening the second component or the second module, is connected to the floor assembly. The second component which is fastened to the floor assembly is located on that side of the end wall which faces rearward in the vehicle longitudinal direction. Thus, the second component is a component which can be arranged or is arranged in an interior of the motor vehicle. The second joining direction running downward in the vehicle vertical direction is understood here as meaning that the second module, and thus in particular the second component, is moved downward in the vehicle vertical direction relative to the floor assembly in order to fasten the second module or the second component, for example directly, to the floor assembly. The first and the second joining directions thus run in an opposite direction. When the components are fastened to the floor assembly, the components can be connected, that is coupled, to each other, in particular data-transmittingly, electrically and/or fluidically, via the media feedthrough opening of the connecting part. An assembly process also referred to as a joining process for fastening the respective module or the respective component to the floor assembly can thus also comprise connecting the components via the media feedthrough opening, specifically in particular without further joining directions or joining movements of the components having to be provided in addition to the joining directions. The components can thus be connected to one another with a particularly low effort via the media feedthrough opening. This is because the orientation of the media feedthrough opening permits the respective joining direction of the respective component or the respective module. The components can be fastened in any sequence. For example, the second component can be fastened to the floor assembly and then the first component can be fastened to the floor assembly or vice versa.

In a further refinement, it is provided that an, in particular preassembled, connection panel is arranged in the media feedthrough opening, via which the components and/or the further components are connected to one another data-transmittingly, electrically and/or fluidically, in particular through the end wall or the media feedthrough opening. Thus, before the respective fastening of the respective component or the respective module in the media feedthrough opening, the connection panel can be arranged in the media feedthrough opening. The, in particular horizontally oriented, connection panel permits the connection of the components via the media feedthrough opening when the components are in their installed position in the motor vehicle or the motor vehicle body, that is, in particular when the respective component or the respective module is fastened to the floor assembly. The connection panel preferably has at least one line element, via which the components are connected to each other data-transmittingly, electrically and/or fluidically. Of course, for example, a plurality of such line elements can be provided. Thus, the components are connected to one another data-transmittingly, for example, via at least one first line element of the connection panel. The components are connected to one another electrically, for example, via a second line element of the connection panel. The components are connected to one another fluidically, for example, via at least one third line element. Thus, a vehicle concept with an integrated, in particular horizontally oriented, connection panel on the end wall can be made possible as a central module interface, in order, for example, to restrict all of the line passages of the end wall to one opening. For example, only one assembly step in the vertical direction is necessary for this connection panel.

In a further refinement, it is provided that the components are connected in an automated manner, in particular by way of direct contacting. This means that the aforementioned connection of the components, that is, the connection of the components via the media feedthrough opening of the connecting part of the end wall, takes place in an automated manner, for example in the form of direct contacting. This means that the outlay on assembly can be kept particularly low. Fastening the first module in the first joining direction to the floor assembly and arranging the first component on the forward facing side of the end wall can also be carried out in an automated manner. Furthermore, fastening the second module in the second joining direction to the floor assembly and the arrangement of the second component on the rearward facing side of the end wall can be carried out in an automated manner.

In a further refinement, it is provided that the first module has a drive device, an electrical energy store, an axle support and/or a chassis of the motor vehicle. The first module may therefore also be referred to as a drive module and/or chassis module. In other words, the first module is fastened to the floor assembly in the first joining direction running upward in the vehicle vertical direction, as a result of which the first module, together with the first component, the drive device, the electric energy store, the axle support and/or the chassis, is fastened to the floor assembly in the first joining direction, i.e., is connected to the floor assembly. The method can thus comprise an assembly step, also referred to as a marriage. The assembly can thus be particularly simplified, because when joining the first module having the drive device, the electric energy store, the axle support and/or the chassis, the first component can be connected to the second component via the media feedthrough opening.

The motor vehicle can be driven by way of the drive device. Thus, the drive device has at least one motor which can be an electric machine. The electrical energy store is preferably designed as a battery or as a rechargeable battery. Preferably, the electric machine can be supplied by way of the electrical energy store with energy stored in particular in the electrical energy store or chemically bound, in order to drive the motor vehicle. The axle support can be understood as meaning in particular a subframe or an auxiliary frame.

In a further refinement, it is provided that the first component is a thermal management module. This means that the first module having the thermal management is fastened to the floor assembly in the first joining direction. Alternatively or additionally, it is provided, for example, that the second component is an interior air conditioning device. This means that the second module having the interior air conditioning device is fastened to the floor assembly in the second joining direction. The thermal management module and the interior air conditioning device can thus be connected to each other with particularly little effort via the media feedthrough opening when installing the modules. Complex horizontal line passages through the end wall that are particularly complicated for the assembly can be avoided because, as a result of the connecting part having the media feedthrough opening, the media feedthrough opening is a vertical line passage based on the vehicle vertical direction. The connection of the thermal management module and the interior air conditioning device to each other can thus already be carried out, in particular automatically, when the modules are joined.

In a further refinement, it is provided that the second module at least partially forms a cockpit of the motor vehicle. In other words, the second module has at least part of the, in particular preassembled, cockpit. The second module may therefore also be referred to as an assembly cockpit or a cockpit module. This means that, when the second module is fastened to the floor assembly, the second module together with the cockpit or the part of the cockpit is fastened to the floor assembly in the second joining direction, that is, is connected to the floor assembly. Alternatively or in addition, it is provided, for example, that the second module at least partially forms a cowl provided for a front window of the motor vehicle. In other words, the second module has at least one, in particular preassembled, part of the cowl, in particular with respect to the lower part in the vehicle vertical direction. Thus, when the second module is fastened to the floor assembly, the second module together with the cowl or part of the cowl is fastened to the floor assembly, that is, connected to the floor assembly, specifically in the second joining direction. The second module can thus comprise a particularly large number of functions in the form of the cockpit and/or the cowl. Thus, the outlay on production of the motor vehicle can be kept particularly low, because in one assembly step, namely when arranging the second module on the floor assembly, a particularly large number of functions of the motor vehicle can thus already be implemented without further assembly steps being necessary.

The cockpit preferably has at least one instrument panel, which may also be referred to as a dashboard. For example, the cockpit and/or the instrument panel may have at least one center console.

The cowl can be understood as meaning in particular a front window frame, which is provided for the front window, in particular at least the arrangement of the front window. The cowl can thus be provided to attach the front window. The front window is understood as meaning in particular a windshield of the motor vehicle.

Thus, a large module in the form of the second module (e.g., cockpit/center console), preferably including the cowl structure, can be joined vertically from the top downward. Furthermore, the first module allows a drive, including the thermal management module, to be connected vertically from the bottom upward. These volumes in the form of the modules mentioned can be connected to one another through the end wall via the connection panel. The connection panel is arranged, for example, above an end wall cross member in the vehicle vertical direction.

Further features of the disclosure emerge from the claims, the figures and the description of the figures. The features and combinations of features mentioned above in the description, and the features and combinations of features mentioned below in the description of the figures and/or shown in the figures alone, may be used not only in the respectively specified combination but also in other combinations or alone.

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1 shows a schematic partial sectional view of a motor vehicle according to the disclosure;

FIG. 2 shows a schematic and perspective exploded illustration of modules of a motor vehicle according to the disclosure;

FIG. 3 shows a schematic partial sectional view of modules of a motor vehicle according to the disclosure in an exploded illustration;

FIG. 4 shows a schematic illustration for illustrating a method according to the disclosure;

FIG. 5 shows a schematic partial sectional view for illustrating a method according to the disclosure; and,

FIG. 6 shows a schematic and perspective partial view of a motor vehicle according to the disclosure.

### DETAILED DESCRIPTION OF THE DRAWINGS

Identical or functionally identical elements are provided with the same reference signs in the figures.

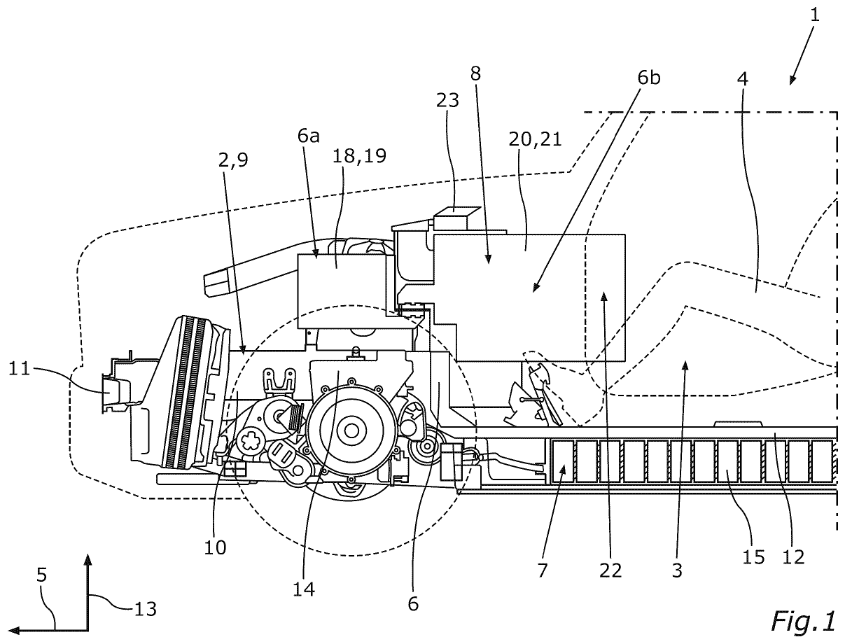

FIG. 1 shows a motor vehicle 1 in a schematic partial sectional view. The motor vehicle has a motor vehicle body 2, which may also simply be referred to as a body or bodyshell. In the present case, the motor vehicle body 2 is designed as a self-supporting body. The motor vehicle has an interior 3, which may also be referred to as vehicle interior. To illustrate the vehicle interior, a person 4 located in the interior 3 is shown in FIG. 1. The interior 3 is at least partially bounded forward in the motor vehicle longitudinal direction 5 by an end wall 6. The end wall 6 is part of the motor vehicle body 2.

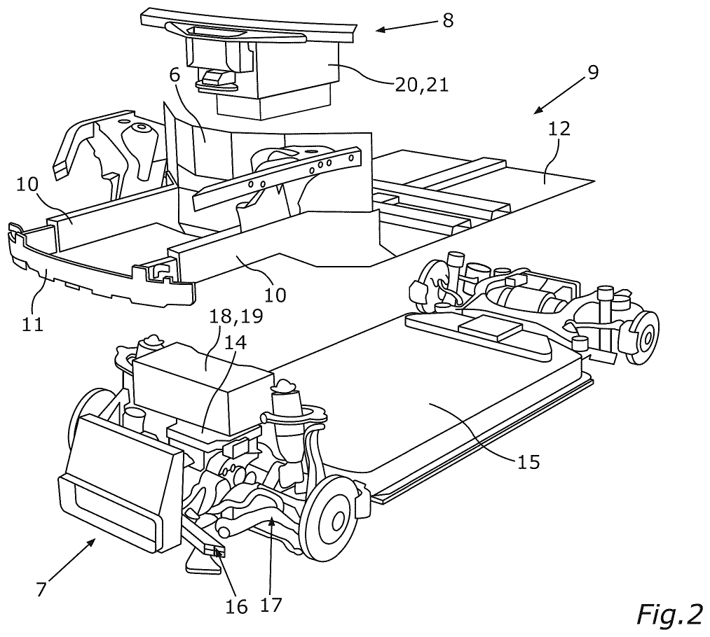

The motor vehicle 1 has a first module 7 and a second module 8 different from the first module 7. This can be seen particularly readily in FIG. 2, in which the motor vehicle 1 is partially illustrated in an exploded illustration. FIG. 2 shows the first module 7, the second module 8 and a floor assembly 9 of the motor vehicle body 2 or the bodyshell. The floor assembly 9 has the end wall 6. Furthermore, the floor assembly 9 here has two longitudinal members 10 which are connected forward in the vehicle longitudinal direction 5 to the end wall 6, which may also be referred to as the engine longitudinal member. The longitudinal members 10 are connected to each other at their end facing forward in the vehicle longitudinal direction 5 via a cross member 11, which is designed, for example, as a bumper cross member and which may also be referred to as a bending cross member. Furthermore, in the exemplary embodiment, the floor assembly 9 has at least one floor element 12, which is designed for example as the main floor. The floor element 12 bounds the interior 3 at least partially downward in the vehicle vertical direction 13 of the motor vehicle.

In the exemplary embodiment, the first module 7 has a drive device 14, which is designed as an electric machine. Furthermore, the first module 7 here has an electrical energy store 15, which is designed as an underfloor store, as a result of which the electrical energy store 15 is arranged or can be arranged under the floor element 12 in the vehicle vertical direction 13. Furthermore, the first module 7 here has an axle support 16 and/or a chassis 17. The first module 7 may therefore be referred to as a drive module and/or chassis module. Furthermore, the first module 7 has at least one first component 18, which is in the form here of a thermal management module 19.

The second module 8 has a second component 20, which is in the form here of an interior air conditioning device 21. In the exemplary embodiment, it is provided that the second module 8 at least partially forms a cockpit 22 and a cowl 23, which is provided for a front window, of the motor vehicle. The cockpit 22 can be arranged or is arranged in the interior 3. The second module 8 may thus also be referred to as a cockpit module. As can be seen in an overall view of FIG. 1 and FIG. 2, the second module 8 is thus a module which can be arranged or is arranged on the interior side, in particular in the interior 3, and the first module 7 is a module which can be arranged or is arranged outside the interior 3.

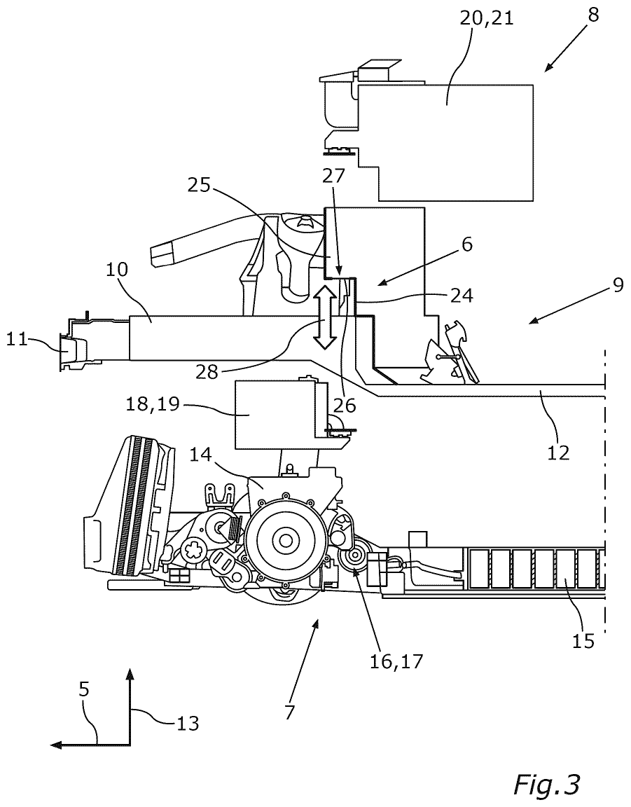

FIG. 3 shows the exploded illustration according to FIG. 2 in a schematic sectional view. The end wall 6 has a lower end wall part 24 and an upper end wall part 25, which extends further upward in the vehicle vertical direction 13 than the lower end wall part 24, and is thus arranged in particular above the lower end wall part 24 in the vehicle vertical direction 13. Furthermore, the end wall 6 has a connecting part 26, via which the lower end wall part 24 and the upper end wall part 25 are connected to each other.

In order to produce, in particular to assemble, the motor vehicle 1 with particularly little effort, it is provided that the connecting part 26 protrudes obliquely or perpendicular from the lower end wall part 24 and the upper end wall part 25. It is provided here that the connecting part 26 protrudes from the upper end wall part 25 to the rear in the vehicle longitudinal direction 5 and protrudes from the lower end wall part 24 to the front in the vehicle longitudinal direction 5. As can be seen in FIG. 3, the connecting part 26 thus forms a step in the end wall 6, that is, a step shape. The lower end wall part 24 and the upper end wall part 25 are connected to each other via this step. As can also be seen in FIG. 3, the lower end wall part 24 extends further to the rear than the connecting part 26 and/or the upper end wall part 25 at least in certain regions, in particular predominantly or completely, in the vehicle longitudinal direction 5. Furthermore, the upper end wall part 25 extends further forward in the vehicle longitudinal direction 5, for example, than the connecting part 26 and/or the lower end wall part 24. The connecting part 26 has at least one, in particular precisely one, media feedthrough opening 27. An aperture in the end wall 6 in the form of the media feedthrough opening 27 is thus arranged in or on the abovementioned step. Owing to the fact that the connecting part 26 has the media feedthrough opening 27 and thus the media feedthrough opening 27 is arranged, as it were, in the connecting part 26, the media feedthrough opening 27 is designed as a vertical aperture or passage of the end wall 6, based on the vehicle vertical direction 13. As a result, at least one line element can be guided through for, in particular data-transmittingly, electrically and/or fluidically, connecting at least the first component 18, which can be arranged or is arranged in front of the end wall 6 in the vehicle longitudinal direction 5, and the second component 20, which can be arranged or is arranged behind the end wall 6 in the vehicle longitudinal direction 5, to each other.

Preferably, however, a plurality of such line elements are provided. Particularly preferably, at least one connection panel is arranged, in particular preassembled, in the media feedthrough opening 27 and preferably has the line element or the line elements, as a result of which the components 18, 20 can be connected or are connected to one another data-transmittingly, electrically and/or fluidically via the media feedthrough opening 27 by way of the connection panel. An axial direction 28 of the media feedthrough opening 27 extends, preferably parallel, to the vehicle vertical direction 13. In other words, the axial direction 28 of the media feedthrough opening 27 and the vehicle vertical direction 13 or a vertical axis, which runs in the vehicle vertical direction, of the motor vehicle 1 run parallel to each other. This means that the axial direction 28 runs in the vehicle vertical direction 13.

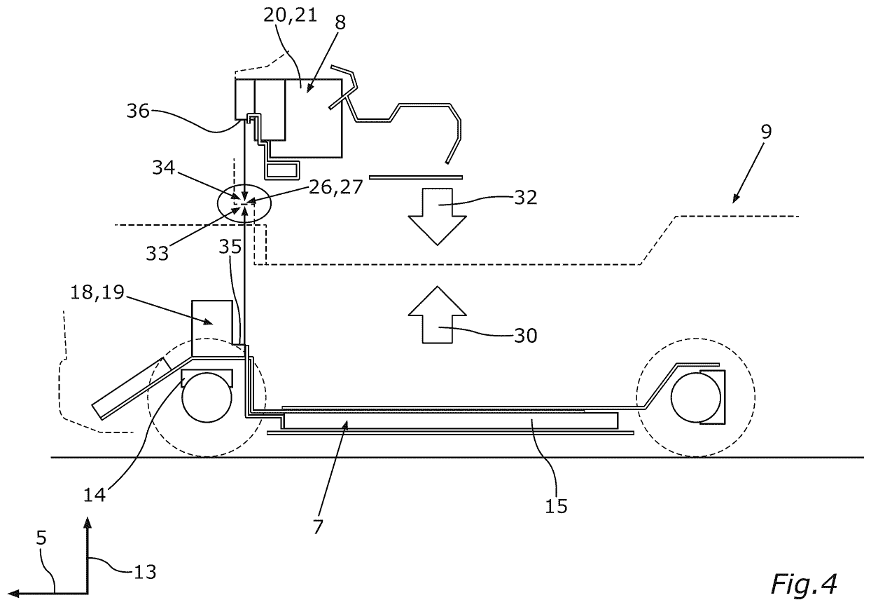

Owing to the fact that the connecting part 26 has the media feedthrough opening 27 as a vertical passage through the end wall 6, a particularly advantageous method for producing the motor vehicle 1, in particular for mounting the modules 7, 8 on the floor assembly 9, can be carried out. This method is explained below. The method is illustrated in FIG. 4, in which the motor vehicle 1 is shown in a schematic partial sectional view.

In the method, the first module 7 having the first component 18 is fastened, for example automatically, in particular directly, to the floor assembly 9 in a first joining direction 30 running upward in the vehicle vertical direction 13. In this case, at least the first component 18 of the first module 7 is arranged, for example automatically, on a side 6a of the end wall 6 facing forward in the vehicle longitudinal direction 5. Further, the second module 8 having the second component 20 is fastened, for example automatically, in particular directly, to the floor assembly 9 in a second joining direction 32 running downward in the vehicle vertical direction 13. In this case, at least the second component 20 is arranged, for example automatically, on a side 6b of the end wall 6 facing rearward in the vehicle longitudinal direction 5, and thus in particular facing the interior 3. The respective joining direction 30, 32 can thus be understood as meaning a respective vertical joining direction, the joining directions 30, 32 preferably running in an opposite direction to each other. During the fastening or during the arrangement in their respective installed position, at least the components 18, 20 of the modules 7, 8 are connected to each other, for example automatically, optionally by way of direct contacting, in particular data-transmittingly, electrically and/or fluidically, via the media feedthrough opening 27.

Thus, for example, a fully preassembled cockpit volume in the form of the second module 8 and a drive module (drive+axles+thermal management module 19) can be connected to the floor assembly 9 in the opposite joining directions 30, 32. A profile of the end wall 6, also referred to as end wall profile, and in particular the step shape caused by the connecting part 26, can also be seen in FIG. 4. The connecting part 26 is oriented at least substantially horizontally with respect to the vehicle vertical direction, as a result of which the media feedthrough opening 27, which is also referred to as “passage end wall”, or the axial direction 28 thereof, is oriented at least substantially vertically.

As can be seen in FIG. 4, the connecting part 26 here has a first support region 33 facing upward in the vehicle vertical direction 13 and a second support region 34 facing downward in the vehicle vertical direction 13. It is provided that, via the first support region 33, the first component 18, for example, a housing of the first component 18 can be supported or is supported, in particular directly, on the end wall 6 via the first support region 33, in particular when the first module 7 is joined to the floor assembly 9. It is provided that, via the second support region 34, the second component 20, for example, a housing of the second component 20 can be supported or is supported, in particular directly, on the end wall 6, in particular when the second module 8 is joined to the floor assembly 9. For this purpose, the first component 18, in particular the housing of the first component 18, has, for example, a contact region 35, which is designed for supporting or for applying to the first support region 33. Furthermore, the second component 20, in particular the housing of the second component 20, has, for example, a second contact region 36, which is designed for supporting or for applying to the second support region 34. Furthermore, the respective contact region 35, 36 can be designed to form the data-transmitting, electrical and/or fluidic connection between the components 18, 20, in particular by way of the connection panel. The contact region 35 may therefore also be referred to as a lower connection panel or as a “connection panel end wall on the outside”. The contact region 36 may also be referred to as an upper connection panel or as a “connection panel end wall on the inside”.

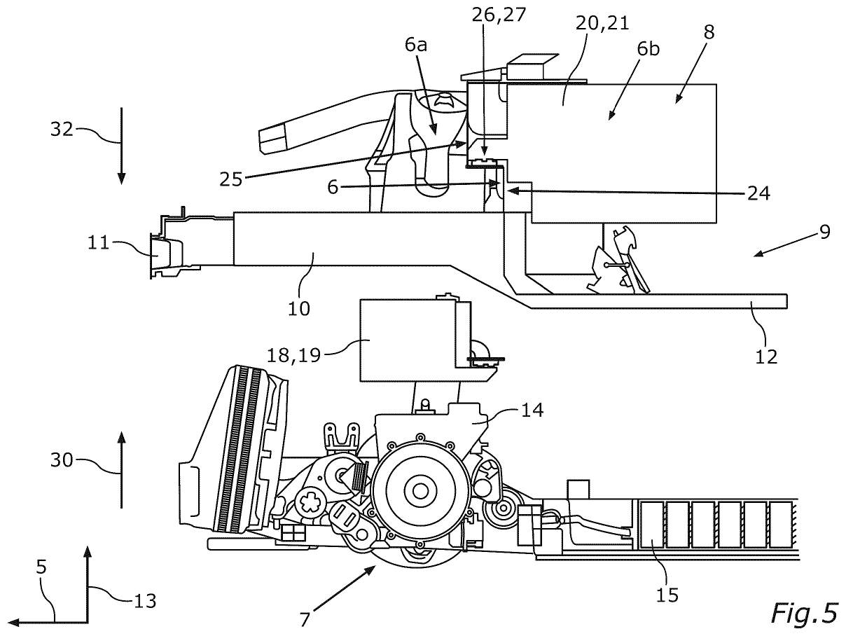

In the exemplary embodiment, the joining of the second module 8 is carried out before the joining of the first module 7. This is illustrated in FIG. 5, in which the modules 7, 8 and the floor assembly 9 are shown in a schematic partial sectional view. In FIG. 5, the second module 8 is already connected to the floor assembly 9, whereas the first module 7 has not yet been connected to the floor assembly 9 and is therefore spaced apart from the floor assembly 9. This means that the method, also referred to as assembly or final assembly, can be carried out as follows: first of all, the floor assembly 9 and the, in particular preassembled, modules 7, 8 can be provided. Then, the second module 8, in particular together with the second component 20, can be joined to the floor assembly 9 in the second joining direction 32. This means that the fastening of the second module 8 having at least the second component 20 to the floor assembly 9 can be carried out in the second joining direction 32, as a result of which at least the second component 20 is arranged on that side 6b of the end wall 6 facing rearward in the vehicle longitudinal direction 5. The first module 7, in particular together with the first component 18, can then be joined to the floor assembly 9 in the first joining direction 30. This means that the fastening of the first module 7 having at least the first component 18 to the floor assembly 9 can be carried out in the first joining direction 30, as a result of which at least the first component 18 is arranged on that side 6a of the end wall 6 facing forward in the vehicle longitudinal direction 5. During this joining or fastening, that is, in particular, if in addition to the second module 8, the first module 7 is also brought into its intended installed position in the motor vehicle 1 or the motor vehicle body 2, when the installed position is reached, in particular by reaching the installed position, the connection of the components 18, 20 via the media feedthrough opening 27 of the connecting part 26 of the end wall 6 can be carried out, in particular without a separate joining step and in particular without a separate line passage through the end wall 6. Thus, when the installed position of the modules 7, 8 is reached or by reaching the installed position, which is provided in the motor vehicle 1, the aforementioned connection of the components 18, 20 can be undertaken, in particular automatically.

In other words, the cockpit module in the form of the second module 8 can be joined in preassembled form from above, based on the vehicle vertical direction 13, in particular together with the interior air conditioning device 21 also referred to as heating air conditioning unit. Subsequently, the preassembled first module 7, which may also be referred to as a drive module, in particular together with the thermal management module 19, can be joined to the floor assembly 9 from below, based on the vehicle vertical direction 13.

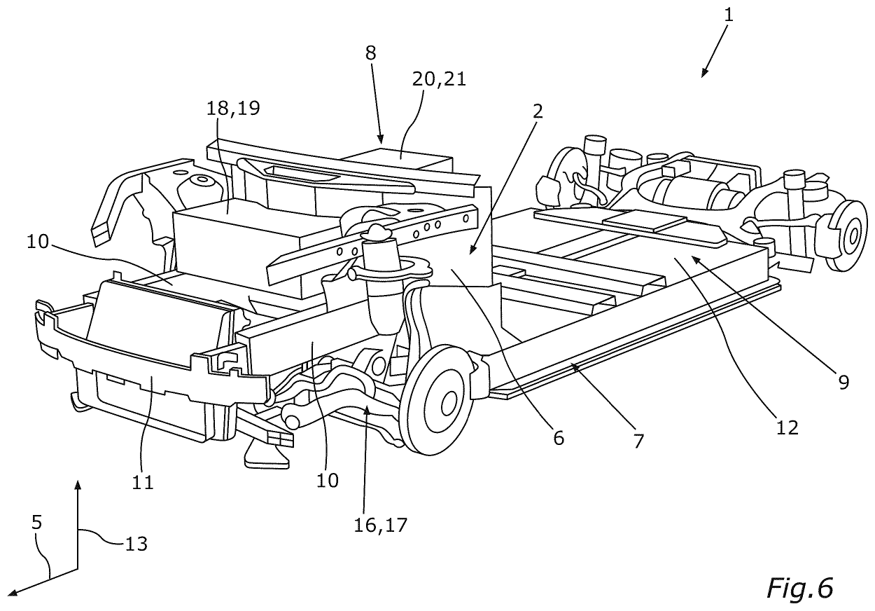

The installed position of the modules 7, 8 is illustrated in FIG. 1, in which the joining processes mentioned are already completed. This is also illustrated in FIG. 6, in which a schematic and perspective partial view of the motor vehicle 1, in particular the modules 7, 8 and the floor assembly 9, is shown.

Overall, it can be seen that the design of the end wall 6 and the method make it possible to realize a horizontally oriented media interface in the form of the media feedthrough opening 27 or the connection panel, which may also be referred to as a core module concept. Here, joining of the second module 8 enables vertical joining of a fully preassembled cockpit (including air conditioning unit, all the, for example, partly water-cooled main control units and a power distributor for the interior 3). In this case, all of the electrical and/or electronic lines and media lines, which are to be guided from the interior 3 through the end wall 6 into the front region, also referred to as the exterior, can be combined to form the integrated connection panel. This connection panel can be joined together with the cockpit or an assembly referred to as “assembly cockpit” in the vertical direction from the top downward against a correspondingly horizontally designed opening in the end wall 6 in the form of the media feedthrough opening 27 and, in particular in an automated manner, screwed to the end wall 6 and preferably sealed. In the next step, the so-called “marriage” with the preassembled volumes of the BEV drive (comprising a high-voltage store with integrated high-voltage storage peripherals of an electric drive machine mounted on the front axle support and/or electric drive machine mounted on the rear axle support) can be carried out. The chassis, an integrated thermal management volume, an electrical and/or electronic line package and a media line package on the high-voltage store, which leads from the front end to the rear end, and a counterpart to the connection panel of the end wall 6 can also be preassembled. This connection panel can bring together all of the electrical and/or electronic lines and media lines of a vehicle exterior region (connection of front end cable harness, media lines, thermal management). The marriage can take place in a vertical direction from the bottom upward, wherein a counterpart to the connection panel of the end wall 6 in the form of the contact region 35 can be connected, for example in a partially automated or fully automated manner, to the previously joined connection panel of the end wall 6 (for example wheel connectors or similar). Further advantages of this connection panel design are that an extended volume, which is mounted in the marriage can permit a complete preassembly of all of the lines in the exterior region with considerably improved accessibility, which can mean a further saving on time. Furthermore, improved sound insulation of the end wall 6 with respect to the exterior region can be made possible, since there are no further apertures in the end wall 6, in particular in the vertical region of the end wall 6, apart from the media feedthrough opening 27. This means that the end wall 6 can be free of further apertures or through openings with respect to the media feedthrough opening 27. The disclosure can be particularly advantageous in connection with “steer by wire” and “brake by wire”. This is because “steer by wire” and “brake by wire”, which may also be collectively referred to as drive-by-wire, in principle require fewer end wall passages, which can permit, for example, a redesign of the end wall 6 or an end wall region in the form of the connecting part 26 having the media feedthrough opening 27. A further boundary condition may be a vehicle modularization, which is also referred to as drive-cap vehicle modularization, in which a greenhouse, that is, a glazed region of the motor vehicle 1, can be joined in the final assembly after completion of the interior.

The foregoing disclosure has been set forth merely to illustrate the invention and is not intended to be limiting. Since modifications of the disclosed embodiments incorporating the spirit and substance of the disclosure may occur to persons skilled in the art, the invention should be construed to include everything within the scope of the appended claims and equivalents thereof.

### LIST OF REFERENCE SIGNS

1 Motor vehicle
2 Motor vehicle body
3 Vehicle interior
4 Person
5 Vehicle longitudinal direction
6 End wall
6a Forward facing side
6b Rearward facing side
7 First module
8 Second module
9 Floor assembly
10 Longitudinal member
11 Cross member
12 Floor element
13 Vehicle vertical direction
14 Drive device
15 Electrical energy store
16 Axle support
17 Chassis
18 First component
19 Thermal management module
20 Second component
21 Interior air conditioning system
22 Cockpit
23 Cowl
24 Lower end wall part
25 Upper end wall part
26 Connecting part
27 Media feedthrough opening
28 Axial direction
30 First joining direction
32 Second joining direction
33 First support region
34 Second support region
35 First contact region
36 Second contact region

What is claimed is:

1. An end wall for a motor vehicle body, comprising:
a lower end wall part,
an upper end wall part, which extends further upward in the vehicle vertical direction than the lower end wall part, and
a connecting part, via which the lower end wall part and the upper end wall part are connected to each other,
wherein the connecting part protrudes obliquely or perpendicular from the lower end wall part and the upper end wall part, and has a media feedthrough opening through which at least one line element can be guided for connecting a first component, which is to be arranged in front of the end wall in the vehicle longitudinal direction, and a second component, which is to be arranged behind the end wall in the vehicle longitudinal direction.

2. The end wall according to claim 1, wherein:
an axial direction of the media feedthrough opening extends parallel to the vehicle vertical direction or at an angle which is less than 45 degrees.

3. The end wall according to claim 1, wherein:
the connecting part protrudes from the upper end wall part to the rear in the vehicle longitudinal direction and protrudes from the lower end wall part to the front in the vehicle longitudinal direction.

4. The end wall according to claim 1, wherein:
the line element for connecting a thermal management module, as the first component, and an interior air conditioning device, as the second component, can be guided through the media feedthrough opening.

5. The end wall according to claim 1, wherein:
the connecting part has a first support region which faces downward in the vehicle vertical direction and via which the first component can be supported on the end wall, and a second support region which faces upward in the vehicle vertical direction and via which the second component can be supported on the end wall.

6. A motor vehicle having an end wall according to claim 1.

7. A method for producing a motor vehicle having a bodyshell with a floor assembly, wherein the floor assembly has an end wall which has a lower end wall part, an upper end wall part, which extends further upward in the vehicle vertical direction than the lower end wall part, and a connecting part which protrudes obliquely or perpendicular from the lower end wall part and the upper end wall part, and via which the lower end wall part and the upper end wall part are connected to each other, and wherein at least the following steps are carried out:
fastening a first module having at least one first component to the floor assembly in a first joining direction running upward in the vehicle vertical direction, wherein at least the first component is arranged on a side of the end wall facing forward in the vehicle longitudinal direction,
fastening a second module having at least one second component to the floor assembly in a second joining direction running downward in the vehicle vertical direction, wherein at least the second component is arranged on a side of the end wall facing rearward in the vehicle longitudinal direction, and
connecting the components via a media feedthrough opening of the connecting part of the end wall.

8. The method according to claim 7, wherein:
a connection panel is arranged in the media feedthrough opening, via which the components and/or further components are connected to one another data-transmittingly, electrically and/or fluidically.

9. The method according to claim 7, wherein:
the components are connected in an automated manner by way of direct contacting.

10. The method according to claim 7, wherein:
the first module has a drive device, an electrical energy store, an axle support, and/or a chassis of the motor vehicle.

11. The method according to claim 7, wherein:
the first component is a thermal management module and/or the second component is an interior air conditioning device, and/or
the second module at least partially forms a cockpit and/or a cowl, which is provided for a front window of the motor vehicle.
